(19) United States
(12) Patent Application Publication
(10) Pub. No.: US 2025/0226675 A1
(43) Pub. Date: Jul. 10, 2025

(54) ENERGY STORAGE SYSTEM AND PROTECTION UNIT

(71) Applicant: GS Yuasa International Ltd., Kyoto-shi (JP)

(72) Inventors: Tsutomu UENO, Kyoto-shi (JP); Takuma SHIN, Kyoto-shi (JP); Yutaro MITANI, Kyoto-shi (JP); Takashi IKEDA, Kyoto-shi (JP); Atsuya SUZUKI, Kyoto-shi (JP); Takafumi AKAGI, Kyoto-shi (JP)

(21) Appl. No.: 19/093,489

(22) Filed: Mar. 28, 2025

Related U.S. Application Data
(63) Continuation of application No. PCT/JP2023/033347, filed on Sep. 13, 2023.

(30) Foreign Application Priority Data
Sep. 30, 2022 (JP) 2022-157227

(51) Int. Cl. H02J 7/00; H01M 10/48; H01M 50/251; H01M 50/296; H01M 50/51; H01M 50/583

(52) U.S. Cl. CPC H02J 7/0031; H01M 10/48; H01M 50/251; H01M 50/296; H01M 50/51; H01M 50/583

(57) ABSTRACT

An energy storage system includes a housing, a bank including a plurality of energy storage devices connected in series, and a protection unit to open and close a power line of the bank. A plurality of the banks are housed in the housing, and a plurality of the protection units respectively provided for the plurality of banks are housed in the housing.

### CROSS REFERENCE TO RELATED APPLICATIONS

This application claims the benefit of priority to Japanese Patent Application No. 2022-157227 filed on Sep. 30, 2022 and is a Continuation Application of PCT Application No. PCT/JP2023/033347 filed on Sep. 13, 2023. The entire contents of each application are hereby incorporated herein by reference.

### BACKGROUND OF THE INVENTION

### 1. Field of the Invention

The present invention relates to energy storage systems and protection units.

### 2. Description of the Related Art

JP 6455282 B2 discloses a container type energy storage unit. A plurality of energy storage modules are supported on a battery board arranged in a container.

### SUMMARY OF THE INVENTION

In the field of industrial energy storage systems, a configuration in which a plurality of energy storage devices are connected in series in order to generate a high voltage of several hundred volts [V] to more than 1000 V is referred to as a bank. In JP 6455282 B2, a single control device arranged in a container controls charging and discharging of a plurality of banks.

In order to expand the use of renewable energy and promote energy management, there is an increasing need for energy storage systems. A reduction in the total cost of an energy storage system including assembly cost and maintenance cost of the energy storage system is required.

Example embodiments of the present invention provide energy storage systems (ESS) each achieving improved ease of assembly and maintenance.

An energy storage system according to an example embodiment of the present invention includes a housing, a plurality of banks each including a plurality of energy storage devices connected in series, and a plurality of protection units respectively provided for the plurality of banks to open and close a power line of the respective bank. The plurality of the banks are housed in the housing, and the plurality of the protection units are housed in the housing.

According to example embodiments of the present invention, energy storage systems achieve improved ease of assembly and maintenance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an energy storage system according to an example embodiment of the present invention.

FIG. 2 is a block diagram illustrating an electrical configuration of an energy storage system according to an example embodiment of the present invention.

FIG. 3 is a perspective view of a protection unit included in an energy storage system according to an example embodiment of the present invention.

FIG. 4 is a block diagram illustrating an electrical configuration of a protection unit included in an energy storage system according to an example embodiment of the present invention.

### DETAILED DESCRIPTION OF THE EXAMPLE EMBODIMENTS

Hereinafter, example embodiments of the present invention will be described.

(1) An energy storage system includes a housing, a plurality of banks each including a plurality of energy storage devices connected in series, and a plurality of protection units respectively provided for the plurality of banks to open and close a power line of the respective bank. The plurality of the banks are housed in the housing, and the plurality of the protection units are housed in the housing.

In the present specification, “energy storage device” may be an energy storage cell, or may be an energy storage module in which a plurality of energy storage cells are connected in series and/or in parallel.

The energy storage device may be a lithium ion battery, but is not limited to this, and may be another chargeable and dischargeable secondary battery or a capacitor.

The protection unit provided for each bank to open and close a power line of each bank is small and lightweight as compared with a single (large) protective device that opens and closes power lines of a plurality of banks. By using a small and lightweight protection unit, housing of the protection unit in the housing is facilitated, and ease of assembly of the energy storage system is improved.

Further, since each of the small and lightweight protection units is detachable, only a specific protection unit that needs to be replaced can be replaced, and thus, maintenance of the energy storage system is improved.

The energy storage system is provided as, for example, a product of a voltage band exceeding 1000 V or a product of a voltage band less than 1000 V, by changing the number of energy storage devices connected in series. The protection unit provided for each bank as described above has high versatility and can be applied to a plurality of types of products of different voltage bands. For this reason, mass production effects such as cost reduction and improvement in component procurement feasibility can be obtained.

(2) In the energy storage system according to (1) above, a plurality of the energy storage devices of each bank may be arranged in line in a vertical direction in the housing, and the protection unit of each bank may be arranged above or below each bank, and a plurality of the protection units may be arranged in line in a lateral direction in the housing.

The energy storage system may be assembled at an installation site of the energy storage system, or may be assembled in a factory and transported to an installation site. In any case, since a plurality of energy storage devices are connected to provide a high-voltage (for example, approximately 1000 V) electric facility, the energy storage system is desirably designed in an easy-to-understand manner so that a worker does not make a mistake in wiring in order to improve safety.

As in the configuration described above, by arranging a plurality of energy storage devices of each bank in the vertical direction and arranging a plurality of protection units in the lateral direction above or below the banks, a worker can intuitively understand wiring work at the time of assembly.

By arranging the protection unit of each bank above or below each bank, a wiring (for example, a wire harness) connecting a bank and the protection unit can be shortened. For this reason, a wiring can be easily routed. Further, at the time of maintenance, a worker can easily understand a correspondence relationship between a bank and the protection unit.

(3) In the energy storage system according to (1) or (2) above, each of a plurality of the protection units may be applicable to a high-voltage product among a plurality of types of energy storage system products of different voltage bands.

The protection unit applied to a high voltage product (for example, 1200 V) in a product lineup has sufficient withstand voltage, and thus is also applicable to a low voltage band (for example, 600 V) product and has high versatility. With such a protection unit, mass production effects such as cost reduction and improvement of component procurement feasibility can be obtained.

(4) In the energy storage system according to (2) above, a dimension in a lateral direction of the protection unit may correspond to a dimension in a lateral direction of the energy storage device of each bank.

The word “correspond” may mean the same or substantially the same dimension, or may mean a value obtained by adding a lateral dimension of inter-bank clearance to a lateral dimension of the energy storage device.

By setting the lateral dimension (width dimension) of the protection unit to such a value, in a case where each bank includes the energy storage devices arranged in one row in the vertical direction, a plurality of the protection units can be arranged in line in the lateral direction in a limited space in the housing above or below a plurality of banks.

(5) In the energy storage system according to any of (1) to (4) above, each protection unit may include a support including a front panel, a positive terminal and a negative terminal which are provided on the front panel and to which a plurality of the energy storage devices defining the bank are electrically connected, and an external positive terminal and an external negative terminal that are provided on the front panel and to which an external circuit (main circuit, another bank) is electrically connected.

In the present specification, “terminal” includes a connector in its meaning. The positive terminal and the negative terminal, and the external positive terminal and the external negative terminal may preferably include connectors, and a conductive portion is preferably not exposed to the outside.

As a result of providing the positive terminal, the negative terminal, the external positive terminal, and the external negative terminal on the front panel, a worker can easily access these terminals even in a state where the protection unit is housed in the housing, so that wiring work at the time of assembly and maintenance is easy.

(6) In the energy storage system according to any of (1) to (5) above, each protection unit may further include an opening and closing unit that is supported by a support and configured to open and close at least any of a power line between the positive terminal and the external positive terminal and a power line between the negative terminal and the external negative terminal. By causing the support to support the opening and closing

unit in advance, an opening and closing function for a power line (a protective function of the energy storage system) can be implemented only by a worker performing wiring of a terminal of the front panel at the time of assembly, and ease of assembly of the energy storage system is improved.

(7) In the energy storage system according to any of (1) to (6) above, each protection unit may further include a management unit that is supported by the support and configured to acquire current flowing through the power line.

Because the support is provided to support a management unit (for example, a battery management unit (BMU)) of each bank, a dedicated member for supporting and housing the management unit is unnecessary. Further, ease of assembly of the energy storage system is improved.

(8) In the energy storage system according to (7) above, the opening and closing unit may include a circuit breaker that is openable and closable by an electric signal from the management unit.

The circuit breaker may include a magnet contactor or a relay.

As a result of the circuit breaker being supported by the support in advance and opened and closed in accordance with an electric signal from the management unit, an opening and closing function for a power line can be implemented only by a worker performing wiring of a terminal of the front panel at the time of assembly. For this reason, ease of assembly of the energy storage system is improved.

In applications such as absorption of fluctuation in renewable energy, a large number of energy storage systems housed in a container or a building are used. When the circuit breaker is of a manually closed type (for example, a molded case circuit breaker (MCCB)), it is necessary for a worker to enter a container or a building at the start of operation (at the start of energization), access each of a large number of energy storage systems, and manually close the circuit breakers of a plurality of protection units in each energy storage system. On the other hand, by using the circuit breaker that can be opened and closed by an electric signal from the management unit, it is not necessary for a worker to operate each protection unit, and work at the start of operation is significantly simplified.

(9) In the energy storage system according to (8) above, the opening and closing unit may include a fuse connected in series to the circuit breaker. A minimum cut-off current of the fuse may be smaller than a maximum cut-off current of the circuit breaker.

Since the opening and closing unit has a fuse connected in series to the circuit breaker, a power line can be reliably cut off even when large current is flowing.

The minimum cut-off current of the fuse means a current required for the fuse to cut off. The maximum cut-off current of the circuit breaker means a maximum current that can be cut off by the circuit breaker. If the circuit breaker is to cut off current that exceeds the maximum cut-off current of the circuit breaker, there is a possibility that an arc is generated between contacts of the circuit breaker and the current cannot be cut off, and the circuit breaker is broken.

By providing the fuse with a minimum cut-off current smaller than a maximum cut-off current of the circuit breaker, it is possible to cause the fuse to blow first and then open a current line by the circuit breaker at the time of occurrence of an abnormal event such as an external short circuit. With such a configuration, a power line can be opened (cut off) with high reliability.

By using the circuit breaker that can be opened and closed by an electric signal, it is not necessary for a worker to operate each protection unit, and work at the time of assembly and maintenance is significantly simplified.

(10) A protection unit includes a battery container, a plurality of banks each including a plurality of energy storage devices connected in series, and a plurality of protection units respectively provided for the plurality of banks to open and close a power line of the respective bank. A dimension in a lateral direction of each of the plurality of protection units corresponds to a dimension in a lateral direction of the plurality of energy storage devices. The plurality of the banks are housed in the battery container. The plurality of energy storage devices in each of the plurality of banks are arranged in line in a vertical direction in the battery container. The plurality of the protection units are detachably housed in the battery container. The respective protection unit of each of the plurality of banks is located above or below the respective bank. The plurality of protection units are arranged in line in a lateral direction in the battery container.

(11) In the protection unit according to (10) above, the plurality of protection units may include three to six protection units detachably arranged in line in the lateral direction of the battery container.

(12) The protection unit according to (10) or (11) above may be applicable to a high-voltage product among a plurality of types of energy storage system products of different voltage bands. Hereinafter, example embodiments of the present

invention will be described in detail with reference to the drawings.

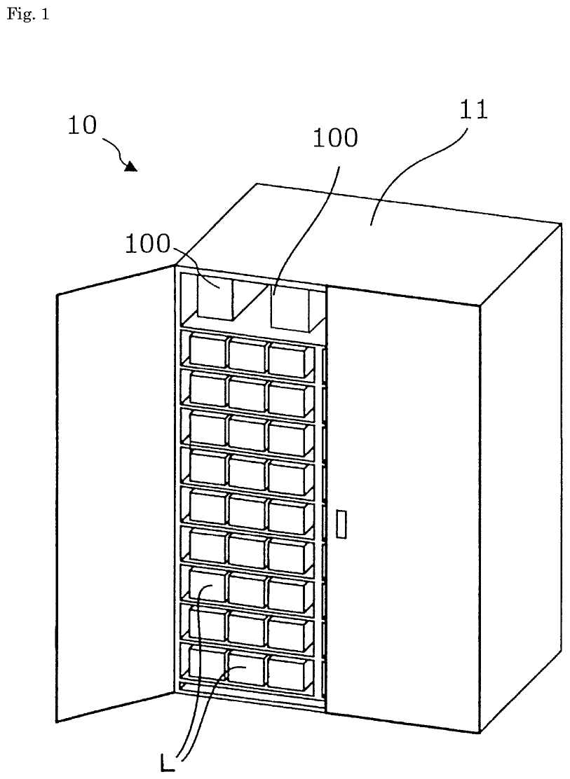

As illustrated in FIG. 1, an energy storage system 10 includes a battery container 11 made from metal and defining a housing, and a plurality of energy storage modules L as energy storage devices are housed in the battery container 11. A plurality of the energy storage modules L are arranged in a plurality of groups (banks) and connected by wiring (not illustrated). The battery container 11 illustrated in FIG. 1 houses three banks including two rows in a vertical direction of the energy storage modules L.

In the example of FIG. 1, each bank is configured by electrically connecting in series a total of eighteen of the energy storage modules L in two rows in the vertical direction, for example. The number of energy storage modules of each bank can be optionally selected. For example, a bank may include one and a half rows in the vertical direction of the energy storage modules L or one row in the vertical direction of the energy storage modules L.

The battery container 11 includes an opening and closing door on a front surface, and a plurality of plates (shelves) are provided at intervals in the vertical direction in the inside. Although not illustrated, an exhaust port is provided in a back wall of the battery container 11. The housing is not limited to the battery container 11 including such an opening and closing door (front wall), and may be a shelf on which a plurality of plates are provided at intervals in the vertical direction and on which the energy storage module L can be visually recognized from the front surface of the housing.

The energy storage module L may be configured by connecting a plurality of energy storage cells (for example, lithium ion battery cells) in series and/or in parallel. The energy storage cell may be a prismatic cell, a cylindrical cell, or a laminate-type cell (pouch cell). The energy storage module L has an elongated shape (for example, a rectangular parallelepiped shape) extending from the front surface of the battery container 11 toward the back wall. The energy storage module L is inserted between shelves from the front surface of the battery container 11.

A protection unit 100 is arranged above each bank (for example, on an uppermost shelf in the battery container 11). In the example of FIG. 1 in which three banks are housed in the battery container 11, three of the protection units 100 are arranged in line in a lateral direction in the battery container 11. The protection unit 100 has an elongated shape extending from the front surface of the battery container 11 toward the back wall.

Although not illustrated, a connector or a terminal for electrical connection with the energy storage module L or the protection unit 100 adjacent in the vertical direction is provided on a front surface of each of the energy storage modules L.

Since a corresponding one of the protection units 100 is immediately above a bank, a wiring (for example, a wire harness) connecting the bank (the energy storage module L arranged uppermost) and the protection unit 100 can be shortened, and the wiring can be easily routed. Further, it is easy for a worker to understand a correspondence relationship between a bank and the protection unit 100 at the time of assembly and maintenance.

The energy storage system 10 of the present example embodiment is provided as a product in a different voltage band by changing the number of the energy storage modules L included in one bank. For example, as illustrated in FIG. 1, two rows in the vertical direction of the energy storage modules L are connected in series to define one bank, and three of the banks are housed in the battery container 11, so that the energy storage system 10 of 1200 V can be provided. In the example of FIG. 1, dimensions of the battery container 11 are set such that a battery housing space becomes substantially full when three banks including two rows in the vertical direction of the energy storage modules L are housed. Above the housed three banks, three corresponding ones of the protection units 100 are detachably housed in the battery container 11.

Although not illustrated, in a case where a single or integrated (large) protective device that protects all three banks is housed in the battery container 11, such a protective device is large and heavy, and thus assembly work becomes troublesome. In particular, in a case where the protective device is housed in an upper portion of the battery container 11, the burden on a worker is large.

As compared with such a case, three of the protection units 100 provided for banks as illustrated in FIG. 1 are small and lightweight, and can be easily housed in an upper portion of the battery container 11. Since each of the protection units 100 is detachable, only the specific protection unit 100 that needs to be replaced can be replaced.

Although not illustrated, products of different voltage bands such as 600 V, 750 V, and 900 V can be provided by reducing the number of the energy storage modules L defining a bank.

For example, in a case of the energy storage system 10 of 600 V, the energy storage modules L in one row in the vertical direction are connected in series to define one bank. In order to improve energy density of the energy storage system 10, six banks are housed in the battery container 11, for example. In this case, six corresponding ones of the protection units 100 are detachably housed in the battery container 11 above the six banks.

The protection unit 100 applied to a highest voltage product (1200 V) in a product lineup has sufficient withstand voltage, and thus is also applicable to a low voltage band (for example, 600 V) product and has high versatility. Since the protection unit 100 as described above can be applied to a plurality of types of products in different voltage bands, mass production effects such as cost reduction and improvement in component procurement feasibility can be achieved.

Further, since the protection unit 100 as illustrated in FIG. 1 is small and light in weight as compared with an integrated (large) protective device, the protection unit 100 can be produced by a small number of workers and is easy to produce.

An integrated protective device is desired to be manufactured for a 1200 V product (for example, three banks are housed in the battery container 11) and for a 600 V product (for example, six banks are housed in the battery container 11). It is preferable to stock a plurality of types of protective devices having different sizes in a production line. On the other hand, as for the protection unit 100 of FIG. 1, ones with the same specifications can be applied to products of different voltage bands, and for this reason, the protection units 100 can be handled easily in a production line and stocked easily.

Therefore, the protection unit 100 contributes to reduction in production cost of the energy storage system 10.

As described above, in a case where one row in the vertical direction of the energy storage modules L are connected in series to define one bank, six banks and six of the protection units 100 are housed in the battery container 11, for example. A dimension in the lateral direction (width dimension) of each of the protection units 100 is set so as to correspond to the width dimension of the energy storage module L of each bank.

For example, the width dimension of the protection unit 100 is set to a value obtained from an equation below.

protective unit width dimension≤(module width dimension+inter-bank clearance width dimension)

By setting the width dimension of the protection unit to such a value, in a case where each bank includes energy storage devices arranged in one row in the vertical direction, six of the protection units 100 can be arranged in line in the lateral direction in a limited space in the housing above or below the bank, for example.

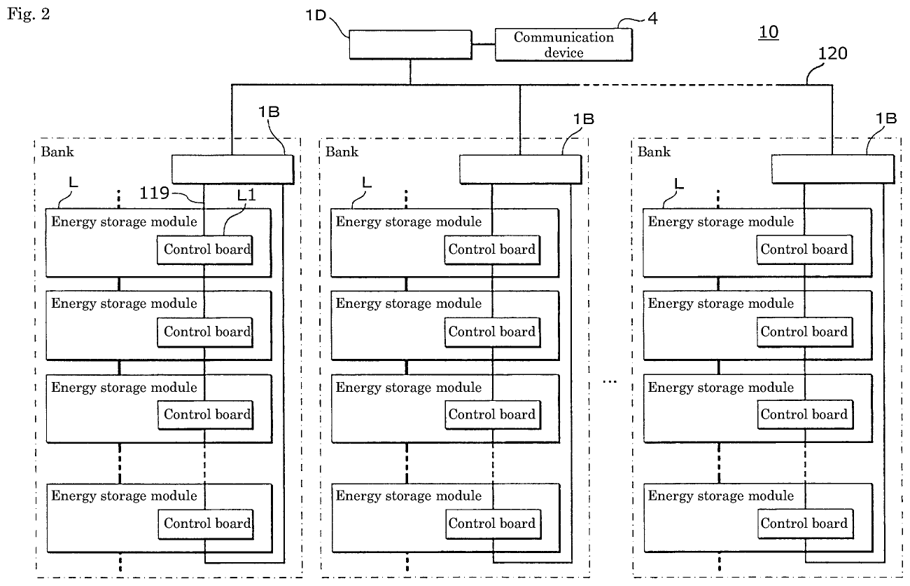

FIG. 2 illustrates an electrical configuration of the energy storage system 10. In FIG. 2, the protection unit 100 is not illustrated. The energy storage modules L are connected in series to define a bank. As described above, in the present example embodiment, three banks are housed in one battery container, for example. The energy storage system 10 has a hierarchical structure of a bank and a domain in which a plurality of banks are connected in parallel. A power line of each bank is connected to a main circuit line (for example, a bus bar through which large current can flow) not illustrated.

In the example of FIG. 2, one management unit 1 is provided for each bank and a domain. In a case where the management unit 1 provided in a bank and the management unit 1 provided in a domain are distinguished, the former is referred to as a management unit 1B, and the latter is referred to as a management unit 1D. The management unit 1B provided in each bank communicates with a control board (cell management unit) L1 with a communication function built in the energy storage module L in the bank by serial communication via a communication line 119. The management unit 1B acquires state data (measurement data, such as cell voltage, module voltage, and the like) of an energy storage cell in the energy storage module L. The management unit 1B also acquires temperature data measured in the energy storage module L and current data measured for each bank. The management unit 1B may execute management processing such as detection of abnormality of a communication state.

The management unit 1D provided in a domain can communicate with the management unit 1B of a bank via a communication bus 120. The communication bus 120 is, for example, a CAN bus. The communication bus 120 may alternatively be a LAN cable or a communication medium compatible with ECHONET/ECHONETLite (registered trademark).

The management unit 1D of a domain may aggregate state data acquired by the management unit 1B of a bank. A communication device 4 is connected to the management unit 1D of a domain. The communication device 4 transmits state data acquired from each of the management units 1B via the management unit 1D.

The communication device 4 may be a terminal device (measurement monitor) that communicates with the management unit 1 to receive information on an energy storage device, or may be a controller compatible with ECHONET/ECHONETLite.

The communication device 4 may also be an independent device, for example, a router-type communication device. The communication device 4 may be a network card type device (network interface card).

The communication device 4 can cause each of the management units 1B to open and close a magnet contactor to be described later in response to an instruction from an external device (for example, a terminal of a worker).

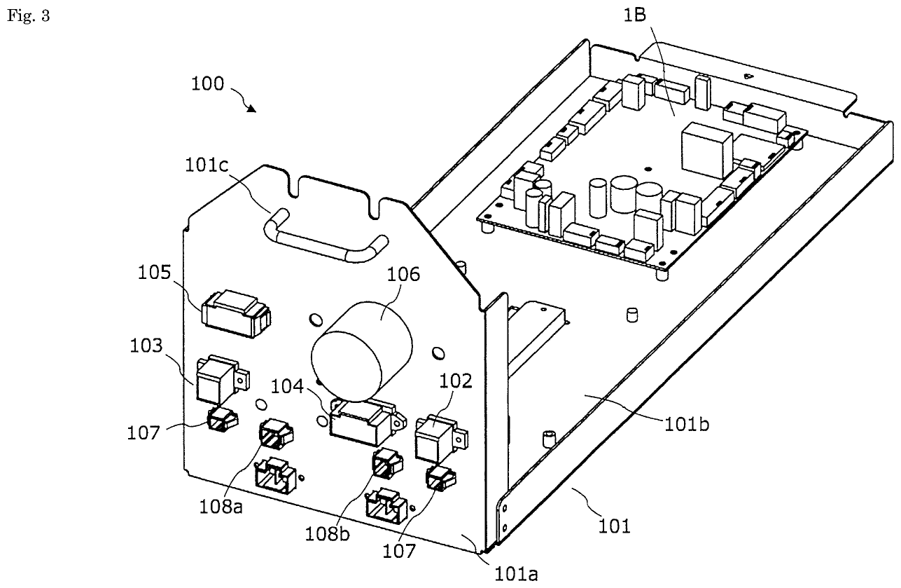

As illustrated in FIG. 3, the protection unit 100 includes a support 101 including a front panel 101a. In the protection unit 100 according to the present example embodiment, the front panel 101a and a lower panel 101b extending in a direction orthogonal to the front panel 101a (a direction from the front surface of the battery container 11 toward the back wall) are integrally formed by sheet metal. The management unit 1B is supported on the lower panel 101b. The weight of the protection unit 100 is reduced without providing a panel above the opposite side of the lower panel 101b.

A positive terminal connector 102 and a negative terminal connector 103, to which a positive power line and a negative power line of the energy storage module L defining a bank are connected respectively, are provided on a surface of the front panel 101a. The positive terminal connector 102 preferably is a resin molded positive terminal, and the negative terminal connector 103 preferably is a resin molded negative terminal.

Further, an external terminal connector 105 to which a main circuit line (not illustrated) is electrically connected is provided on a surface of the front panel 101a. The main circuit line is an example of an external circuit of the protection unit 100. The main circuit line may be a bus bar arranged in the battery container 11. In the external terminal connector 105, an external positive terminal and an external negative terminal are resin-molded terminals.

Since conductive portions of the positive terminal connector 102, the negative terminal connector 103, and the external terminal connector 105 are not exposed, a worker can safely perform wiring work. The external terminal connector 105 is different in shape from the positive terminal connector 102 and the negative terminal connector 103, and this can prevent erroneous wiring.

On a surface of the front panel 101a, an intermediate terminal connector 104 to which a power line between two energy storage modules in the middle of a plurality of the energy storage modules L defining a bank is connected is provided. The intermediate terminal connector 104 preferably is a resin molded intermediate terminal. The intermediate terminal connector 104 is different in shape from the positive terminal connector 102, the negative terminal connector 103, and the external terminal connector 105, so that erroneous wiring can be prevented.

Further, a service plug 106 is provided on a surface of the front panel 101a.

Two CAN communication connectors 107 are provided on a surface of the front panel 101a.

Further, on a surface of the front panel 101a, a receiving communication connector 108a and a transmission communication connector 108b for serial communication with a control board L1 of each of the energy storage modules L in a bank are provided.

A handle 101c is provided on a surface of the front panel 101a. When a worker installs the protection unit 100 on an uppermost shelf illustrated in FIG. 1 while supporting the lower panel 101b from below and holding the handle 101c at the time of assembling the energy storage system 10, an upper side of the protection unit 100 is covered by an upper wall of the battery container 11. In the state illustrated in FIG. 1, a worker can access the front panel 101a of the protection unit 100. A worker electrically connects a bank and the protection unit 100, and a main circuit line and the protection unit 100 through the positive terminal connector 102, the negative terminal connector 103, the external terminal connector 105, and the intermediate terminal connector 104.

Since a conductive portion such as a terminal block is not exposed on a surface of the front panel 101a, a worker can safely perform wiring work.

Because the support 101 is provided to support the management unit 1B, a dedicated member for supporting and housing the management unit 1B is unnecessary. Since attachment of the management unit 1B is completed by housing the protection unit 100 in the battery container 11, ease of assembly of the energy storage system 10 is improved.

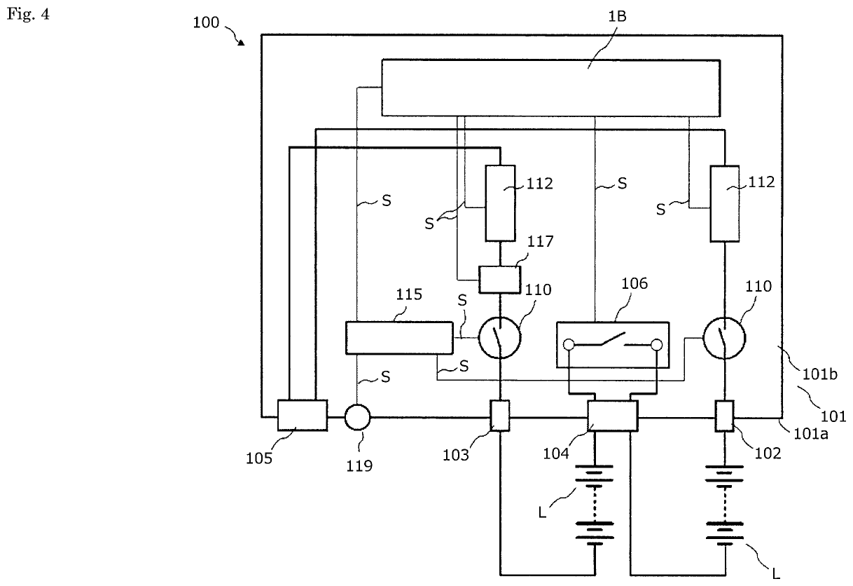

FIG. 4 illustrates an electrical configuration of the protection unit 100. The lower panel 101b of the support 101 is provided with an opening and closing unit to open and close a positive power line between the positive terminal connector 102 and the external terminal connector 105. Further, the lower panel 101b is provided with an opening and closing unit to open and close a negative power line between the negative terminal connector 103 and the external terminal connector 105, and a current sensor 117 (for example, a Hall sensor) that detects current flowing through the negative power line. In FIG. 4, reference sign S denotes a signal line.

The opening and closing unit includes a magnet contactor 110 that can be opened and closed by an electric signal from the management unit 1B, and a fuse 112 connected in series to the magnet contactor 110. An electrical signal from the management unit 1B is provided to each of the magnet contactors 110 via an LED substrate 115.

An open and closed state of the magnet contactor 110, that is, an energized state of a bank cannot be directly viewed in the front view as illustrated in FIG. 1. In view of the above, when both of the magnet contactors 110 are closed (are on), an LED 119 provided on the front panel 101a is turned on to externally display that a bank is in an energized state.

Because the support 101 supports such an opening and closing unit in advance, it is possible to implement an opening and closing function for a power line (protective function of the energy storage system 10) only by a worker performing wiring of a terminal connector of the front panel 101a at the time of assembly.

In the present example embodiment, the magnet contactor 110 that can be opened and closed by an electric signal from the management unit 1B is used. In a case where a Molded Case Circuit Breaker (MCCB) of a manually closed type is used as an opening and closing unit that can turn on all the magnet contactors 110 in the energy storage system 10 when an on instruction is given to the communication device 4 (see FIG. 2) from a terminal (PC or tablet) of a worker, the worker needs to operate each one of the protection units 100 at the time operation of the energy storage system 10 is started. In a case where a large number of the energy storage systems 10 are installed, this work is very complicated. According to the present example embodiment, work at the start of operation (or at the start of energization after maintenance) is significantly simplified.

A minimum cut-off current of the fuse 112 illustrated in FIG. 4 is preferably smaller than a maximum cut-off current of the magnet contactor 110.

By providing the fuse 112 with the minimum cut-off current that is smaller than the maximum cut-off current of the magnet contactor 110, it is possible to cause the fuse 112 to blow first and then open a current line by the magnet contactor 110 at the time of occurrence of an abnormal event such as an external short circuit. With such a configuration, a power line can be turned off (cut off) with high reliability.

As illustrated in FIG. 4, the front panel 101a is provided with the service plug 106 that is provided between two of the energy storage modules L in the middle of a bank including a plurality of the energy storage modules L to open and close a power line of the bank. FIG. 4 illustrates a state in which the service plug 106 is turned off, but the service plug 106 is on during operation of the energy storage system 10.

When the service plug 106 is turned off (power line is cut off), even a 1200 V energy storage system can be set to 750 V or less. For this reason, it is possible to improve safety during assembly and maintenance of the energy storage system.

The LED 119 provided on the front panel 101a may also be configured to light up when both the magnet contactors 110 and the service plug 106 are closed (are on).

The present invention is not limited to the above-described example embodiments.

As the energy storage device, instead of the energy storage module L, an elongated energy storage cell extending from a front surface toward a back surface of the battery container 11 (housing) may be housed in a housing.

The opening and closing unit may be provided on a front surface or a back surface of the front panel of the support. The opening and closing unit is not limited to one that can be opened and closed by an electric signal from the management unit.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage system comprising:
a housing;
a plurality of banks each including a plurality of energy storage devices connected in series; and
a plurality of protection units respectively provided for the plurality of banks to open and close a power line of the respective bank; wherein
the plurality of the banks are housed in the housing; and
the plurality of the protection units are housed in the housing.

2. The energy storage system according to claim 1, wherein
the plurality of energy storage devices of each of the plurality of banks are arranged in line in a vertical direction in the housing; and
the protection unit of each of the plurality of banks is arranged above or below the respective bank, and the plurality of protection units are arranged in line in a lateral direction in the housing.

3. The energy storage system according to claim 1, wherein each of the plurality of protection units is applicable to a high-voltage product among a plurality of types of energy storage system products of different voltage bands.

4. The energy storage system according to claim 2, wherein a dimension in a lateral direction of each of the plurality of protection units corresponds to a dimension in a lateral direction of the respective energy storage device of each of the plurality of banks.

5. The energy storage system according to claim 1, wherein each of the plurality of protection units includes:
a support including a front panel;
a positive terminal and a negative terminal that are provided on the front panel and to which the plurality of energy storage devices are electrically connected; and
an external positive terminal and an external negative terminal that are provided on the front panel and to which an external circuit is electrically connected.

6. The energy storage system according to claim 5, wherein each of the plurality of protection units further includes:
an opening and closing unit that is supported by a support and configured to open and close at least any of a power line between the positive terminal and the external positive terminal and a power line between the negative terminal and the external negative terminal.

7. The energy storage system according to claim 6, wherein each of the plurality of protection units further includes:
a management unit that is supported by the support and configured to acquire current flowing through the power line.

8. The energy storage system according to claim 7, wherein the opening and closing unit includes a circuit breaker that is openable and closable by an electric signal from the management unit.

9. The energy storage system according to claim 8, wherein the opening and closing unit includes a fuse connected in series to the circuit breaker.

10. The energy storage system according to claim 1, wherein each of the plurality of energy storage devices is an energy storage module including a plurality of energy storage cells connected in series and/or in parallel, or an elongated energy storage cell extending from a front surface toward a back surface of the housing.

11. The energy storage system according to claim 10, wherein each of the plurality of energy storage devices housed in the housing or each of the plurality of protection units housed in the housing is detachable through an opening and closing door of the housing.

12. An energy storage system comprising:
a battery container;
a plurality of banks each including a plurality of energy storage devices connected in series; and
a plurality of protection units respectively provided for the plurality of banks to open and close a power line of the respective bank; wherein
a dimension in a lateral direction of each of the plurality of protection units corresponds to a dimension in a lateral direction of the plurality of energy storage devices;
the plurality of the banks are housed in the battery container;
the plurality of energy storage devices in each of the plurality of banks are arranged in line in a vertical direction in the battery container;
the plurality of the protection units are housed in the battery container;
the respective protection unit of each of the plurality of banks is located above or below the respective bank; and
the plurality of protection units are arranged in line in a lateral direction in the battery container.

13. The energy storage system according to claim 12, wherein the plurality of protection units include three to six protection units detachably arranged in line in the lateral direction of the battery container.

14. The energy storage system according to claim 12, wherein each of the plurality of protection units is applicable to a high-voltage product among a plurality of types of energy storage system products of different voltage bands.

15. The energy storage system according to claim 12, wherein each of the plurality of protection units includes:
a support including a front panel;
a positive terminal and a negative terminal that are provided on the front panel and to which the plurality of energy storage devices are electrically connected; and
an external positive terminal and an external negative terminal that are provided on the front panel and to which an external circuit is electrically connected.

16. The energy storage system according to claim 15, wherein each of the plurality of protection units further includes:
an opening and closing unit that is supported by a support and configured to open and close at least any of a power line between the positive terminal and the external positive terminal and a power line between the negative terminal and the external negative terminal.

17. The energy storage system according to claim 16, wherein each of the plurality of protection units further includes:
a management unit that is supported by the support and configured to acquire current flowing through the power line.

18. The energy storage system according to claim 17, wherein the opening and closing unit includes a circuit breaker that is openable and closable by an electric signal from the management unit.

19. The energy storage system according to claim 18, wherein the opening and closing unit includes a fuse connected in series to the circuit breaker.

20. The energy storage system according to claim 12, wherein each of the plurality of energy storage devices is an energy storage module including a plurality of energy storage cells connected in series and/or in parallel, or an elongated energy storage cell extending from a front surface toward a back surface of the battery container.
